(19) United States
(12) Patent Application Publication
(10) Pub. No.: US 2007/0087098 A1
(43) Pub. Date: Apr. 19, 2007

(54) Reduction of oil and off-flavors in citrus juice by direct steam heating and flash cooling

(75) Inventors: Girish Subramaniam, Bradenton, FL (US); Craig Philipp, Bradenton, FL (US); D. Scott Lineback, Bradenton, FL (US); Yongsoo Chung, Bradenton, FL (US)

Correspondence Address: BANNER & WITCOFF, LTD.;and ATTORNEYS FOR PEPSICO, 10 SOUTH WACKER DR., CHICAGO, IL, 60606, US

(73) Assignee: Tropicana Products, Inc., Bradenton, FL (US)

(21) Appl. No.: 11/582,643

(22) Filed: Oct. 18, 2006

Related U.S. Application Data
(62) Division of application No. 10/376,792, filed on Feb. 28, 2003, now abandoned.

(51) Int. Cl. A23B 4/005

(52) U.S. Cl. 426/511

(57) ABSTRACT

A method for direct steam pasteurization and de-oiling of citrus juice, and more particularly, orange juice, is provided. In a further embodiment, a method for direct steam pasteurization and flash cooling of citrus juice is provided. The method removes certain undesired flavor components and retains certain desired flavor components and products having enhanced sensory characteristics result.

### FIELD OF THE INVENTION

The present invention is directed to a method for direct steam heating of citrus juice, and more particularly, orange juice. In a further embodiment, the present invention is directed to a method for direct steam heating and flash cooling of citrus juice which removes certain undesired flavor components and retains certain desired flavor components.

### BACKGROUND OF THE INVENTION

When producing fruit juice, and in particular citrus juice such as orange juice, a sterilization process prior to packaging is necessary to prevent spoilage of the product and to inactivate enzymes. This process is generally called pasteurization in the context of the citrus juices.

Conventional orange juice pasteurization involves a slow ramp-up of the juice to a pasteurization temperature of about 200° F. (about 93° C.). During such a process, the juice is at a temperature much greater than consumption temperature, i.e. about 35° F. (about 2° C.), for up to several minutes. During this relatively long period of time, significant product degradation can result. For example, the taste and valuable sensory properties of the juice can be adversely affected.

Another factor adversely affecting the taste of the juice is the presence of diacetyl in the pasteurized juice. Diacetyl is an off-flavor compound caused by microbial degradation of citrus juices which produces a buttery flavor in the juice. Levels as low as 50 parts per billion (ppb) are sensory perceptible in orange juice. Since such an off-flavor is not acceptable in, for example, “not-from-concentrate” (NFC) orange juice, the current practice is to make the less valuable “from concentrate” (FC) orange juice from NFC orange juice that has diacetyl contamination. However, this makes it more expensive to produce NFC orange juice. Accordingly, it is desirable to have a process which makes production of NFC orange juice more cost effective and efficient by offering a method for removal of diacetyl and other off-flavors from the juice.

Other off-flavor compounds that can adversely affect the taste of the juice. include alpha-terpeneol, terpene-4-ol (which are products of acid catalyzed degradation of d-limonene) and carvone (which is oxidation of d-limonene). An important element of the invention is the appreciation that juice having enhanced sensory properties could be produced if off-flavors such as these were prevented from forming or, if present, removed from the juice without removing all of the positive flavor compounds, such as ethyl-2-hexenoate and ethyl-3-hydroxyhexanoate.

Furthermore, FC products typically have a cooked off-flavor due to heat abuse during evaporation. It will be appreciated that an evaporation procedure, which is the standard practice to concentrate a juice, subjects the juice to very harsh thermal conditions to which NFC juice is not subjected. It would be advantageous to eliminate or greatly reduce this cooked off-flavor in, for example, FC orange juice.

Vacuum steam processing is known in other fields. For example, U.S. Pat. No. 2,944,479 (Walsh et al.) is directed to a vacuum-steam processor. The patent is primarily directed to contacting dairy products with steam in a vacuum environment. The object is for the steam to remove odor and flavor volatiles to improve the taste of the dairy products. This patent does mention that the vacuum-steam processor described therein can be used in processing of orange juice, but for a specific purpose, to distill and remove peel oil from the-juice. In such a case, the condensate can be passed through a separator for removing entrained peel oil. The process in this patent, however, is not directed to the selective removal of negative flavor components from the juice which is one of the objectives of the present invention.

The vacuum steam processor in Walsh et al. comprises two chambers and a condenser. Steam and milk are introduced to a vacuum filled first chamber, heating a thin film of milk until the milk reaches the bottom of the chamber. The milk and condensed steam then are sent to the lower pressure second chamber to remove steam and odor and flavor causing volatiles. The milk flows in a thin spiral film down the walls of the second chamber. The processed milk is then transferred elsewhere.

Dasi Industries also has a number of patents directed to the dairy industry and sterilization of milk. These are, for example, U.S. Pat. Nos. 3,771,434, 4,310,496, Re. 32,695, 4,591,463, 5,544,571 and 5,639,499. The first of these, U.S. Pat. No. 3,771,434 (Davies), discloses a basic process of forming milk flow into a thin film which is subjected to steam. The other Dasi Industries patents are similar. They describe a process wherein milk is preheated, filmed, rapidly heated to as high as 300° F. with steam, and flash cooled, to 160° F. Although primarily directed to milk, other liquids such as beer, orange juice and soup are mentioned as being suitable for application by the process and equipment in Re. 32,695. However, the high temperatures used in these patents would likely produce an overcooked off-flavor in juice.

U.S. Pat. No. 5,225,221 (Camden et al.) describes the preparation of calcium-supplemented fruit juice beverages. This patent describes pasteurization using ultra-high temperatures of 212° F. to 260° F. for 2 to 6 seconds. The pasteurization is done by either steam injection or steam infusion. However, the high temperature-time combination disclosed in this patent negatively affects the flavor of juice. The juice then is cooled by a bank of heat exchangers. Such a cooling process is not very fast and slowly reduces the temperature of the juice from the high temperature. As a result, the juice is at the high temperatures for periods well over 1 second. This adversely affects the flavor of the juice. This process also does not remove negative flavor components from the juice.

Accordingly, it is an object of the present invention to overcome the drawbacks in the prior processes and provide a process for pasteurizing citrus juice to remove off-flavor compounds while retaining desired flavor compounds.

Another object is to provide juice products having these characteristics.

### SUMMARY OF THE INVENTION

The present invention is directed to a process or method of heating, blanching, or pasteurization or sterilization of citrus juice and reduction of oil and off-flavors in the juice by rapid heating of the juice by direct contact with steam. Preferably, in the method of the present invention, the residence time of the juice above consumption temperature is significantly reduced than with prior processes, resulting in minimal degradation And thermal abuse of the juice. Either direct steam injection or direct steam infusion can be used for rapidly heating the juice.

In a further embodiment, subsequent to direct steam heating, the juice preferably undergoes rapid flash-cooling under vacuum.

In a further embodiment, prior to rapidly heating the juice, the juice is preheated. Further, after rapid heating, the juice is preferably flash-cooled to approximately the preheat-temperature.

The present invention is suitable for citrus juices, such as for example orange, grapefruit, lime and lemon juice. Preferably, the process is used for pasteurizing orange juice, both not-from-concentrate (NFC) orange juice and from concentrate (FC) orange juice. Additionally, special benefits can result when the invention is used in connection with NFC juice.

Preferably, with the method of the present invention, pectin methylesterase enzyme (PME) inactivation in the juice is achieved. Typically, enzyme inactivation is an objective of traditional citrus juice pasteurization.

An unexpected benefit of the method of the present invention is the prevention of formation of and the selective removal of certain undesired components, such as for example alpha-terpeneol, terpene-4-ol, and carvone. Significantly lower levels of these off-flavor compounds will result in improved flavor in the juice. The retention of certain, key desired flavor components, such as for example ethyl-2-hexenoate, and ethyl-3-hydroxyhexanoate, is another unexpected benefit of the method of the present invention. This phenomenon is believed to apply to some but not all flavor components. An embodiment of the present invention is directed to a better tasting juice with the selective removal of some or all of the above mentioned undesirable components and the retention of some or all of the above mentioned desired components.

Further, the method of the present invention removes diacetyl, when present, from NFC juice. As diacetyl causes juice to be unsuitable for good quality NFC juice, diacetyl removal can lead to significant savings in processing costs and value of the product. Another embodiment of the present invention is directed to a consistently better tasting and more cost-efficient juice having almost all of the diacetyl removed from the NFC juice.

Further, using the method of the present invention, to prepare FC juice leads to a better tasting FC juice. Negative compounds which are formed in the FC evaporation process can be reduced, and flavor attributes enhanced. Another embodiment is directed to a better tasting FC juice. This includes both from concentrated citrus juice and single strength juice reconstituted from concentrated citrus juice.

While in some instances, the method of the present invention may also remove certain desired components from the juice, in a further embodiment of the method of the present invention, these components can be added back to the juice in a flavor add-back step.

Another embodiment of the present invention is directed to a method for pasteurizing citrus juice wherein the raw juice is separated into a high solids stream and a low solids stream. Preferably, the high solids stream would include solids and tight-end juice while the low solids stream would include serum and free-run juice. Preferably, both streams undergo steam heating and flash cooling, but the present invention also contemplates the process being used on only one of the streams. With the method of this embodiment, high oil removal levels up to 93%, and even possibly up to 97%, provide a unique advantage in oil control while not removing compounds that are important to the flavor of the citrus juice. Another embodiment is directed to the resulting better tasting juice.

A further embodiment of the present invention is directed to a method for reducing oil concentration or de-oiling citrus juice without full pasteurization of the juice. Preferably, the method of this embodiment involves direct steam heating the juice to a high temperature but not as high a temperature as pasteurization temperature. The juice is then immediately flash cooled. Preferably, the juice is initially preheated. The result supports the flexibility of the de-oiling process to control oil level in orange juice.

### BRIEF DESCRIPTION OF THE DRAWINGS

FIG. 1 illustrates one embodiment of the present invention for direct steam heating and pasteurization of citrus juice.

FIG. 2 shows the relationship between time and temperature of the present invention versus the conventional method.

FIG. 3 illustrates one embodiment of the present invention for direct steam heating and de-oiling of citrus juice.

FIGS. 4A-4C are graphs showing oil removal efficiency by steam injection as affected by different final temperatures and different incoming, preheat juice temperatures.

FIG. 5 illustrates another embodiment of the present invention.

FIGS. 6A-6D are graphs showing test results using the present invention for removal of negative and retention of positive flavor compounds.

### DETAILED DESCRIPTION OF THE PRESENTLY PREFERRED EMBODIMENTS

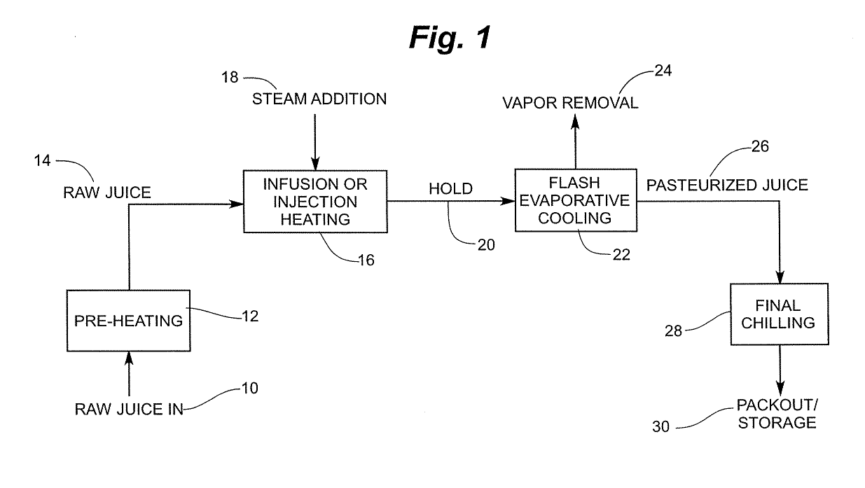

FIG. 1 illustrates the steps of a preferred embodiment of a method of the present invention. In this embodiment, direct steam heating is used to pasteurize citrus juice. Initially, a citrus juice supply (10) is preheated (12). The citrus juice supply can be single strength NFC juice, either freshly extracted, stored or a combination thereof. The citrus juice supply also can be concentrated juice, single strength juice reconstituted from concentrated juice, as well high and low solid streams separated by conventional separation equipment such as centrifuges, finishers, and decanters, or other similar equipment. While the juice can be any citrus juice, orange juice is a preferred embodiment.

Preheating can be done with conventional heating apparatus, such as for example, indirect tubular heating. Preferably, the juice is initially pre-heated to a temperature-between approximately 50° F. to 200° F. (approximately 10C. to 93° C.), more preferably between approximately 70° F. to 180° F. (approximately 21° C. to 82° C.) and even more preferably between approximately 80° F. to 170° F. (approximately 26° C. to 77° C.). The most preferred range is presently between approximately 100° F. to 150° F. (approximately 37° C. to 65.5° C.). The precise temperature is usually application dependent. For example, for NFC juice, a preheating temperature of 140° F. (60° C.) has been found to work well. The time period needed for such pre-heating is equipment dependent.

The preheating step is beneficial for both cost and unit efficiency. For example, it is much more cost efficient and requires much less energy to steam heat the juice from 140° F. (60° C.) to over 210° F. (99° C.) and flash cool back to 140° F. (60° C.) than if the juice has to be steam heated from 35° F. (2° C.) to 210° F. and flash cooled back to 35° F.

Thereafter, the pre-heated raw juice (14) is directly steam pasteurized (16) by infusion or injection heating to ;a high temperature by the addition of steam (18). Preferably, the juice is heated to a temperature above approximately 190° F. (approximately 88° C.) but no higher than approximately 230° F. (approximately 110° C.). For example, good results have been achieved with a heat of 207° F. (97° C.).

With steam injection, the steam is directly added to the stream of raw juice. With steam infusion, the juice enters a steam chamber which also has steam added thereto. Both techniques are within the scope of the present invention. The present invention also contemplates any other way in which steam can be brought into contact with juice. It is also contemplated that the present invention could be used with another food-grade heating medium other than water.

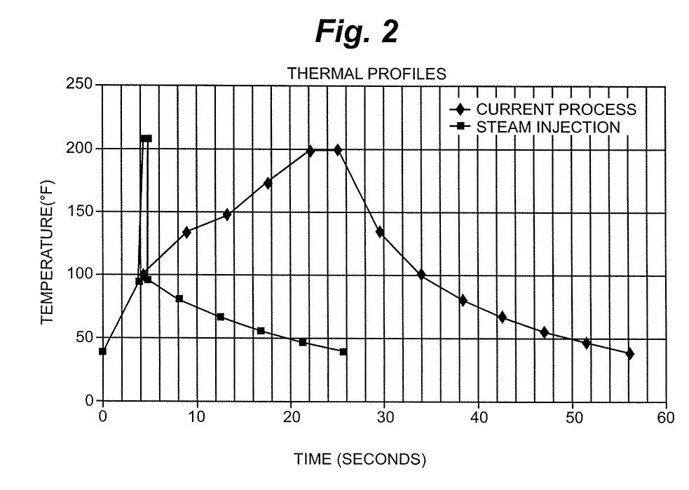

The juice is held at step or location (20) at the required high temperature for microbial and enzyme inactivation for a very short time, preferably, less than 1 second and more preferably, less than 0.5 seconds. The heated juice then undergoes a cooling step (22). It is preferred that the cooling is done by flash vaporization (flash cooling) wherein the vapor (24) is removed. As shown in FIG. 2, utilizing this method of the present invention keeps the juice at a high temperature for a significantly shorter time than with the conventional indirect heating and cooling process. The rapid heat-hold-cool process of the method of the present invention effectively minimizes. thermal abuse. The flash process also serves to remove oil, air and several negative flavor compounds selectively, while essentially maintaining positive compounds. Pasteurized juice (26) is outputted.

This flash vaporization procedure also has the important benefit of removing the steam vapor added to the juice during steam heating. More specifically, an important consideration in NFC orange juice preparation is maintenance of Brix. Brix is a measure of the percent soluble solids in a given weight of juice. For example, in the method of a preferred embodiment of the present invention, by directly adding culinary steam to preheated juice (at approximately 100° F. or 37° C.) and rapidly increasing juice temperature (to approximately 207° F. or 97° C.), followed by a very short hold (approximately 0.5 sec.) and rapidly cooling (to approximately 100° F. or 37° C.) by flash vaporization, any added steam vapor is removed from the juice, maintaining the original Brix level.

The pasteurized juice then is chilled (28) to approximately 35° F. (approximately 2° C.) for packaging or storage (30). The packaging or storage is carried out in accordance with generally known procedures and principles.

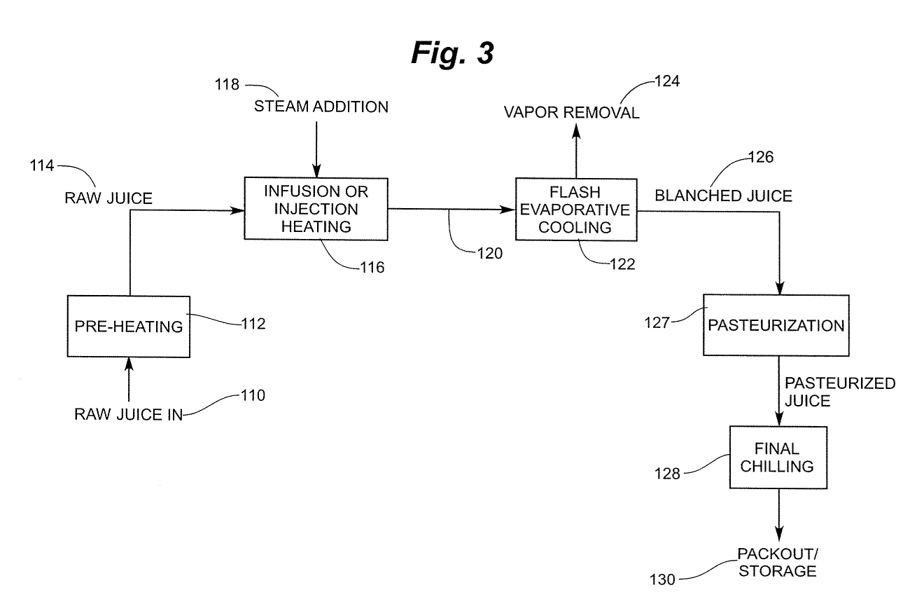

In an alternative embodiment, the method of the present invention can be used for de-oiling citrus juice without pasteurizing the juice. Such a process is shown in FIG. 3 and is similar in many ways to the steps in FIG. 1, though there are some differences. For example, as illustrated in FIG. 3, preferably a raw citrus juice supply (110) is preheated (112) in a similar manner and to similar temperatures as in step (12) of FIG. 1. In this embodiment, the pre-heated raw juice (114) is then directly steam heated (116) by infusion or injection to a high temperature by the addition of steam (118) in a similar manner as in step (16) of FIG. 1, except that the juice in step (116) is only heated to a high temperature of between approximately 100° F. (37° C.) to approximately 210° F. (99° C.), and preferably between approximately 140° F. (approximately 60° C.) to 180° F. (approximately 82° C.). The temperature selected should be one in which the juice may not be pasteurized. The juice remains (120) at that temperature until it is cooled by flash cooling (122) with vapor removal (124) in a manner and to temperatures similar to that described above for step (22) in FIG. 1. The result is a blanched juice (126) with a high percentage of oil removed from the juice.

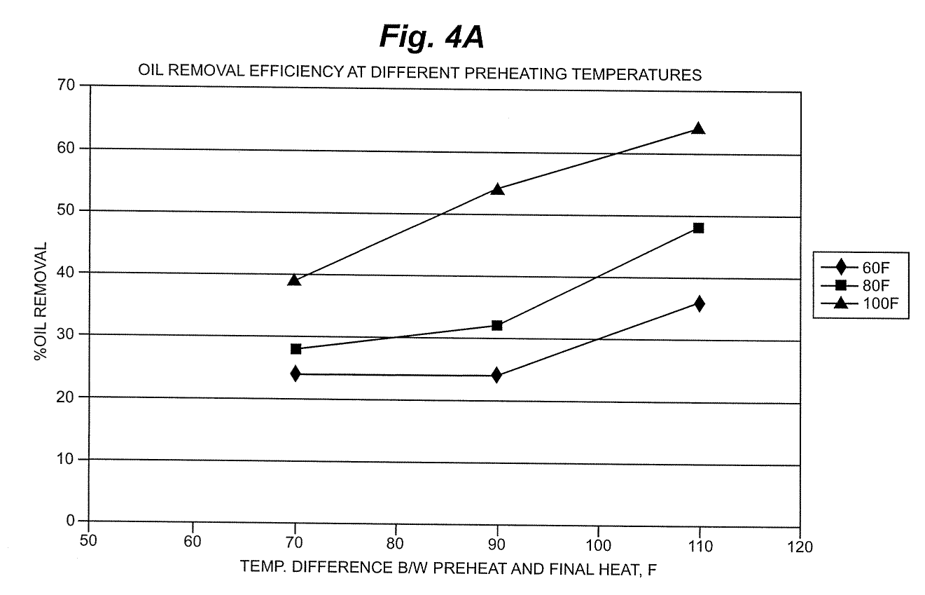

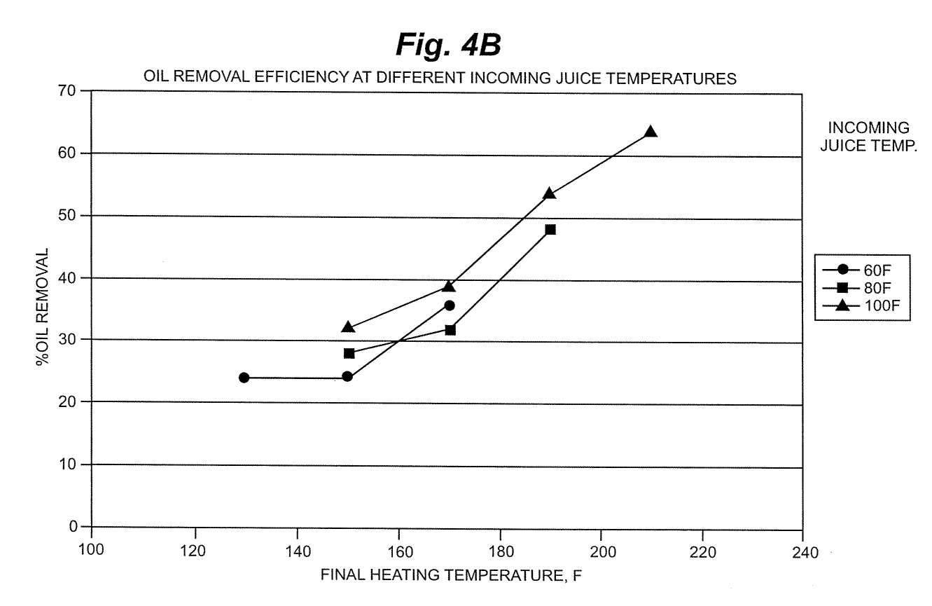

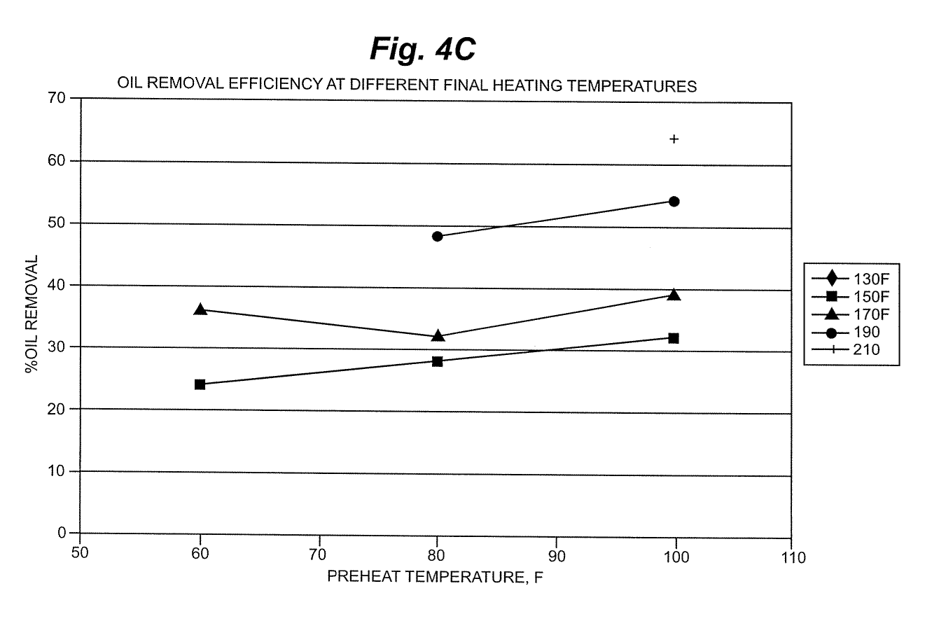

As shown in FIGS. 4A-4C, the oil removal efficiency is greater when the raw juice has been pre-heated to for example 100° F. (37° C.), than when it had been pre-heated to 60° F. (15° C.) or 80° F. (26° C.). Accordingly, it is preferable to pre-heat the juice before direct steam addition. FIGS. 4A-4C also illustrate the improved oil efficiency for the higher pre-heat temperatures for different final heating temperatures. Further, as shown in FIGS. 4A-4C, the higher the temperature achieved after steam injection, the greater the percent of oil removed by flash vaporization.

Thereafter, the blanched juice (126) can be pasteurized (127) using a conventional tubular pasteurization process. The pasteurized juice can then be chilled (128) and packaged or stored (130) in a manner similar to and to a temperature similar to that described for steps (28) and (30) of FIG. 1

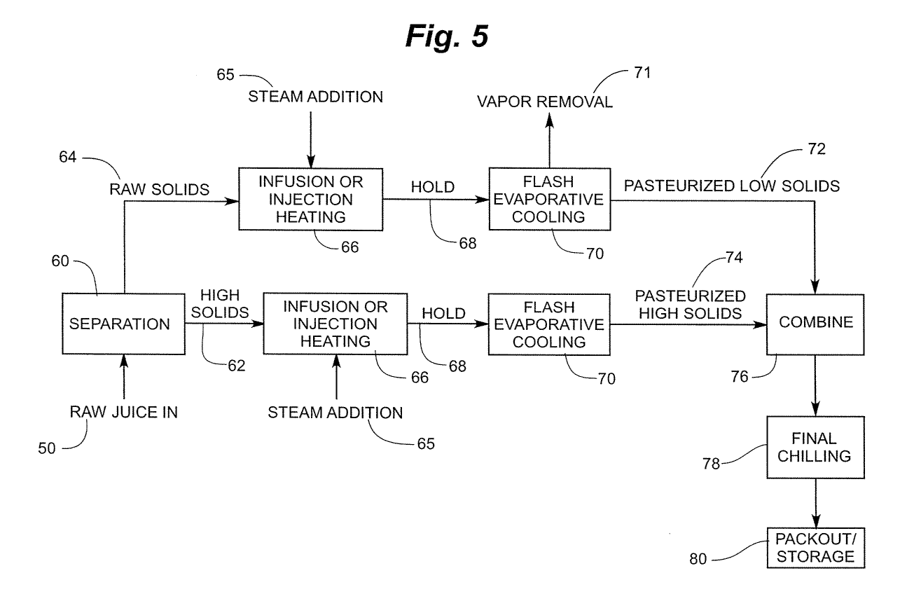

FIG. 5 illustrates another embodiment of the present invention. In this embodiment, steam pasteurization is used for the sterilization of separated high solids and low solids streams. In this embodiment, raw citrus juice (50) is separated (60) into a high solids stream (62) and a low solids stream (64) by conventional separation devices and techniques. Preferably, the streams are pre-heated to a temperature similar to the pre-heating step of FIG. 1, either before or after separation. Either or both the high solids stream (62) and the low solids stream (64) then undergo direct steam infusion or direct steam injection heating (66) by steam addition (65) to heat the high solids and/or low solids to a high temperature similar to the temperature discussed previously for FIG. 1. The heated high solids and low solids are then held (68) at this high temperature for a short period of preferably less than 1 second and more preferably less than 0.5 seconds. Thereafter, both heated streams undergo flash evaporative cooling (70) with vapor removal (71) to produce a pasteurized low solids stream (72) and a pasteurized high solids stream (74). The streams are then combined (76) to form pasteurized juice. Alternatively, the streams can be combined and then flash cooled. Chilling (78) and packaging/storage (80) similar to those steps in FIG. 1 typically then follow. In tests run using this process, after centrifugation to separate the high solids from the low solids, treatment With steam pasteurization resulted in a reduction of oil by up to 93%. Reduction up to 97% is believed possible. In fact, the oil reduction of the split streams was higher than for single strength juice. This surprising result provides a unique method of oil removal at levels not currently available by other methods.

In a further embodiment, the methods of the present invention are for use in from concentrate (FC) juice products either before or after reconstitution to single strength. The steam pasteurization by the methods of the present invention eliminates or greatly reduces the cooked off-flavor due to heat abuse from prior processes and provides a better sensory juice having various sensory properties which are superior than such sensory properties of juices that are otherwise pasteurized.

The present invention will now be illustrated in the following Examples which are not intended to limit the invention.

### EXAMPLE 1

Single strength stored blends of NFC orange juice were tested. The juice contained 40-50% previously frozen whole juice, with the remaining juice in the mixture being freshly extracted juice. The juice was steam pasteurized by steam injection or steam infusion, and a control juice was tubular pasteurized and not steam pasteurized. The steam pasteurized juice was first pre-heated to 100° F. (37° C.) and then steam pasteurized by steam injection or steam infusion to 205° to 207° F. (96° C. to 97° C.) for 0.4 seconds followed by flash cooling to a temperature of 100° F. For the steam pasteurized juice, product residence time above 100° F. (37° C.) was minimized to within 1 second. The indirect tubular process (control juice) involved pasteurization for 3 seconds at 195° F. (90.5° C.), followed by conventional cooling. Samples of the steam pasteurized juice and control juice were collected and stored in one quart glass bottles at 35° F. (2° C.). The samples of the steam pasteurized juice and the control juice were analyzed for sensory and chemical effects at 3 and 6 weeks. Time-0 chemistry and microbiology were also tested. For sensory characteristics, the evaluation was done by a trained panel tasting samples of juice produced from each process. A descriptive sensory analysis method was employed which uses 15-point anchored universal line scales.

Sensory analysis favored steam pasteurization over the prior process of tubular pasteurization (control). Further, microbiological testing found no viable counts of spoilage-causing organisms in the steam pasteurized product. In fact, steam pasteurization delivered the required microbial reduction and inactivation of pectin methyl-esterase enzyme with a high temperature and short time treatment.

For the products aged both 3 weeks and 6 weeks, the samples pasteurized with steam injection and steam infusion were significantly higher in a raw orange sensory characteristic of the descriptive sensory analysis than were the control samples. Raw orange is that portion of the total orange flavor which is typical of unprocessed, freshly squeezed orange juice, free of add backs. It is represented by the pulpy portion of the orange and is considered to contribute positively to flavor.

Both the 3 weeks and 6 weeks aged samples pasteurized with steam injection and steam infusion were also lower than the tubular-pasteurized control sample in the following respects. The steam pasteurized juices had lower scores for the following sensory properties, each being a negative attribute for a citrus juice. The steam-pasteurized juice was significantly lower in an “expressed orange oil” sensory characteristic. This is that portion of orange flavor which is typical of unprocessed orange oil. The steam-pasteurized juice also was significantly lower in a “chemical” sensory characteristic and a “package” sensory characteristic, which recognizes off-flavors associated with petroleum, sulfur, solvents, etc. The steam-pasteurized juice was significantly lower in an “aromatics” sensory characteristic, which recognizes spicy, minty, musty, burnt, etc. sensory sensations. The steam-pasteurized juice was significantly lower in “feeling factors”, which rate chemical interactions of the product with the mouth. Since each of these factors is considered to negatively contribute to flavor, the lower result noted for each indicates improved taste and sensory characteristics for the juice using the direct steam pasteurization methods of the present invention versus conventional indirect tubular heating. These results are shown in Table 1.

TABLE 1

| | Indirect | | |
|---|---|---|---|
| | (control) | Steam Injection | Steam Infusion |
| Raw Orange | 1.2b | 1.4a | 1.4a |
| Expressed Orange Oil | 1.7a | 1.5b | 1.5b |
| Chemical | 0.9a | 0.7b | 0.7b |
| Package | 0.4a | 0.2b | 0.3ab |
| Other Aromatics | 0.5a | 0.4b | 0.5ab |
| Feeling Factors | 1.5a | 1.4b | 1.4b |

Means in the same row with a different letter are significantly different at 90% Confidence level. Other sensory characteristics tested (not listed in table) displayed no significant difference at the 90% Confidence level. The results shown are the average results between the 3 week and 6 week tests.

### EXAMPLE 2

Pasteurization of FC orange juice was tested using direct steam infusion compared with indirect tubular heat exchange (control). The steam infusion procedure involved preheating to 100°° F. (37.8° C.), then pasteurizing for 3 seconds at 200° F. (93.3° C.) by direct steam infusion, and then flash cooling to the preheat temperature. The pasteurization was done for 3 seconds based on the equipment available to compare results to the indirect tubular procedure. The indirect tubular procedure (control juice) involved pasteurizing for 3 seconds at 200° F. (93.3°). The control juice was not preheated prior to pasteurization heating. The control juice was cooled by a tubular cooling system. The juices from both procedures were then cold-filled in quart glass bottles, stored at 35 ° F. (2° C.) and evaluated after 4 weeks of storage for sensory characteristics.

At four weeks, the juice was tasted by a panel using the 15-point anchored universal line scales described in Example 1. The steam pasteurized FCOJ had significantly lower levels, than the indirect tubular pasteurization (control) FCOJ, of the following negative sensory characteristics: “expressed orange oil,” “package” flavors (off-flavors which appear to be associated with packaging materials, such as metal or plastic) and “bitterness” (taste reference represented by caffeine). The results are shown in Table 2. All other flavor test criteria (not listed in table) were substantially the same between the two juices.

TABLE 2

| | Indirect Tubular | Steam Infusion |
|---|---|---|
| | Pasteurization | Pasteurized FCOJ |
| Expressed Orange Oil | 1.7a | 1.5b |
| Package | 0.5a | 0.4b |
| Bitter | 0.8a | 0.6b |

Means in the same row with a different letter are significantly different at 90% Confidence level. Other sensory characteristics tested (not listed in table) displayed no significant difference at the 90% Confidence level.

### EXAMPLE 3

Various juice streams were tested with steam injection system as an alternative pasteurization technique. Fresh Hamlin, fresh Valencia juice, NFCOJ blend juice, FCOJ, and split streams of high solids and low solids were used as the juice source. One item of interest is to compare the oil reduction of the method of the present invention on a typical single strength juice versus using the method on juice that has been separated into a high solids stream and a low solids stream. The juice in this test was pre-heated to temperatures between 140° F. to 160° F., then steam heated to approximately 205° F. The juice was held at the high temperature for a period of time between 0.7 to 1.5 seconds. The juice was then flash cooled to the pre-heat temperature. Table 3 summarizes the oil removal efficiency results

TABLE 3

| | Average/Range | | | | |
|---|---|---|---|---|---|
| Source | initial oil | final oil | % reduction | SD | No. of test |
| Fresh Hamlin | 0.017 | 0.008 | 54.6 | 2.3 | 2 |
| Fresh Hamlin, low solids stream | 0.016 | 0.003 | 81.3 | | 1 |
| Fresh Hamlin, high solids stream | 0.012 | 0.003 | 79.2 | 5.9 | 2 |
| Fresh Valencia | 0.028 | 0.013 | 55.9 | 4.0 | 8 |
| Fresh Valencia, low solids stream | 0.018-0.043 | 0.002-0.003 | 88.9-93.0 | | |
| Fresh Valencia, high solids stream | 0.021-0.064 | 0.009-0.035 | 45.3-57.1 | | |
| NFCOJ blend | 0.025-0.029 | 0.013-0.016 | 34.4-55.0 | | |
| NFCOJ blend, low solids stream | 0.022 | 0.002 | 93.0 | 3.5 | 2 |
| NFCOJ blend, high solids stream | 0.077 | 0.010 | 86.6 | 8.2 | 3 |
| FCOJ | 0.021 | 0.009 | 57.1 | | 1 |

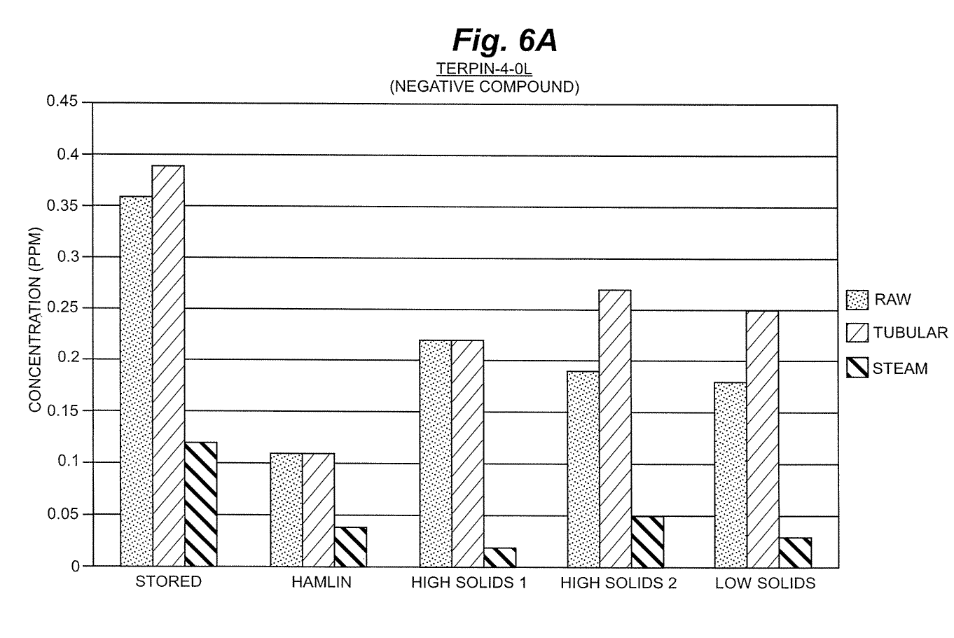

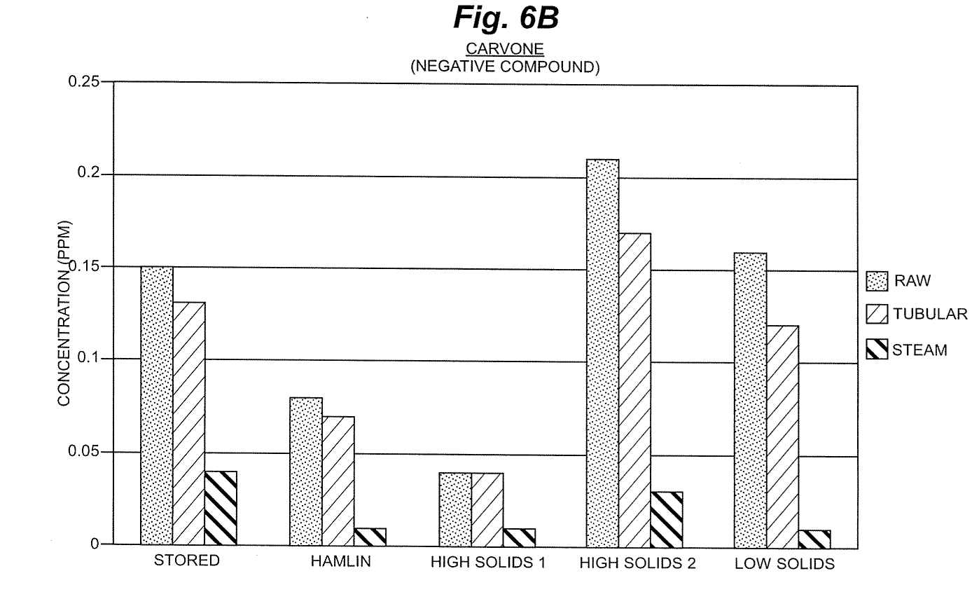

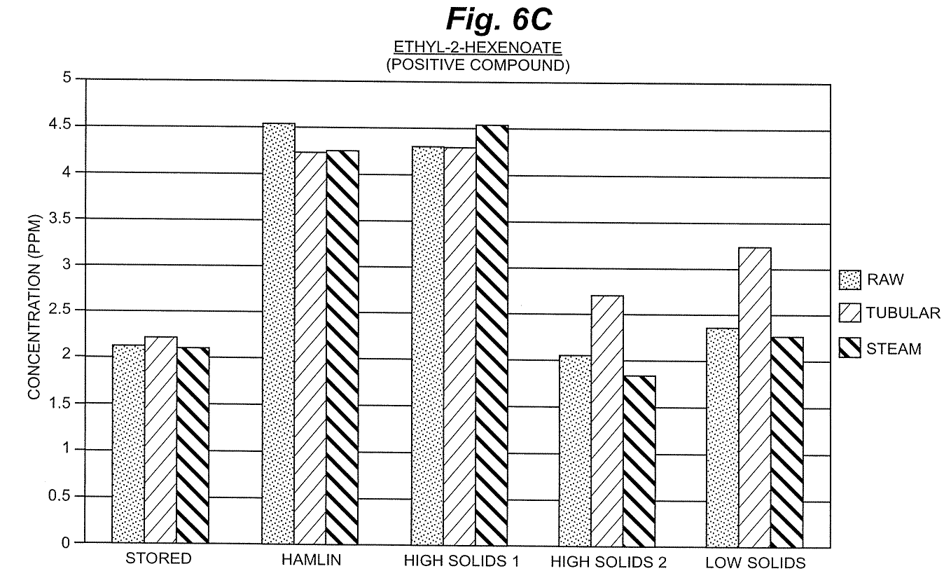

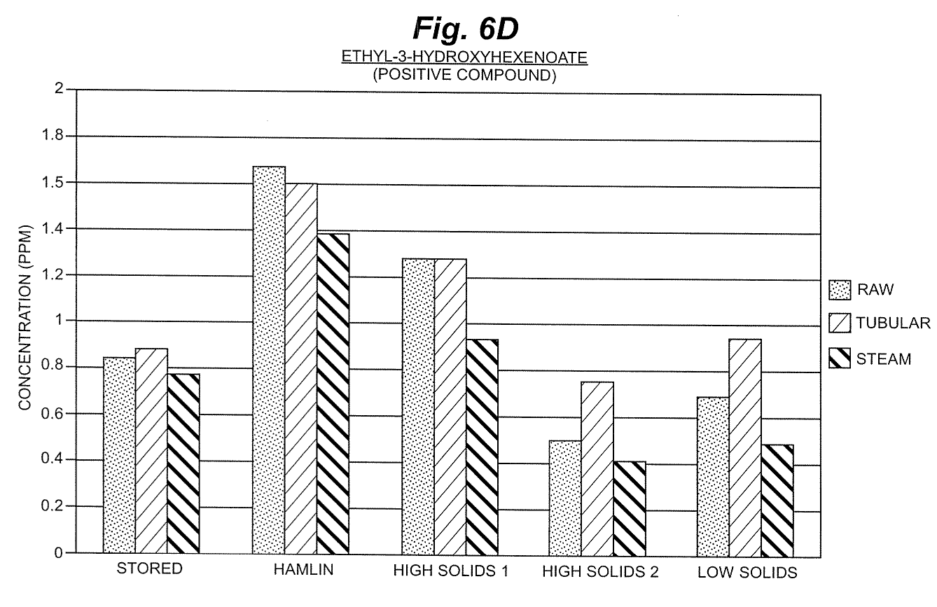

Chemical analysis showed an unexpected phenomenon of selective removal of known negative flavor compounds (See FIGS. 6A, 6B) while retaining known positive compounds (See FIGS. 6C, 6D). Table 4 summarizes FIGS. 6A-6D in numerical format. As shown in FIGS. 6A and 6B, the direct steam heating method of the present invention significantly lowered the amount of negative flavor compounds Terpin-4-ol (FIG. 6A) and Carvone (FIG. 6B) present in the juice, as compared to raw juice and juice pasteurized using the conventional indirect tubular heating method. In some instances with the direct steam heating process of the present invention as shown in FIGS. 6A and 6B, concentrations of these negative flavor compounds are noted to have decreased by more than half of the concentrations in the raw juice or indirect samples. As shown in FIGS. 6C and 6D, the direct steam method of the present invention does riot appreciably affect the desired positive flavor compounds ethyl-2-hexenonate (FIG. 6C) and ethyl-3-hydroxyhexenoate (FIG. 6D). Any differences in concentrations of these positive flavor compounds between processes seen in FIGS. 6C and 6D are within levels of measurement accuracy. The direct steam heating method of the present invention produced a better overall tasting juice than the indirect tubular heating method when considering both the negative and positive flavor compounds

TABLE 4
COMPARATIVE CHEMISTRY (Steam Infusion/Flash Pasteurization)

| | | | HIGH | HIGH | LOW |
|---|---|---|---|---|---|
| | STORED | HAMLIN | SOLIDS 1 | SOLIDS 2 | SOLIDS |
| terpin-4-ol | | | | | |
| Raw | 0.36 | 0.11 | 0.22 | 0.19 | 0.18 |
| Tubular | 0.39 | 0.11 | 0.22 | 0.27 | 0.25 |
| Steam | 0.12 | 0.04 | 0.02 | 0.05 | 0.03 |
| Carvone | | | | | |
| Raw | 0.15 | 0.08 | 0.04 | 0.21 | 0.16 |
| Tubular | 0.13 | 0.07 | 0.04 | 0.17 | 0.12 |
| Steam | 0.04 | 0.01 | 0.01 | 0.03 | 0.01 |
| ethyl-2- | | | | | |
| hexenoate | | | | | |
| Raw | 2.13 | 4.53 | 4.31 | 2.05 | 2.36 |
| Tubular | 2.23 | 4.24 | 4.31 | 2.71 | 3.24 |
| Steam | 2.11 | 4.26 | 4.53 | 1.84 | 2.25 |
| ethyl-3- | | | | | |
| hydroxy- | | | | | |
| hexanoate | | | | | |
| Raw | 0.84 | 1.67 | 1.28 | 0.5 | 0.69 |
| Tubular | 0.88 | 1.6 | 1.28 | 0.75 | 0.94 |
| Steam | 0.77 | 1.39 | 0.93 | 0.41 | 0.49 |

It will be understood that the embodiments and examples of the present invention, which have been described, are illustrative of some of the applications of the principles of the present invention. Numerous modifications may be made by those skilled in the art without departing from the spirit and scope of the invention.

1-79. (canceled)

80. A method for de-oiling citrus juice comprising:
preheating citrus juice to a preheat temperature;
rapidly heating the preheated citrus juice to a de-oiling temperature between approximately 100° F. to 210° F. (approximately 37° C. to approximately 99° C.) by directly combining steam with said preheated citrus juice;
holding said juice at said de-oiling temperature for less than 1 second; and
flash vaporizing said juice to thereby rapidly reduce the temperature of the juice to a flash temperature.

81. The method of claim 80 wherein said de-oiling temperature is between approximately 140° F. to 180° F. (approximately 60° C. to approximately 82° C).

82. The method of claim 80 wherein said preheat temperature and said flash temperature each is between approximately 50° F. to approximately 200° F. (approximately 10° C. to approximately 93° C.).

83. The method of claim 82 wherein said preheat temperature is between approximately 70° F. to approximately 180° F. (approximately 21° C. to approximately 82° C.).

84. The method of claim 83 wherein said preheat temperature is between approximately 80° F. to approximately 170° F. (approximately 26° C. to approximately 77° C.).

85. The method of claim 84 wherein said preheat temperature is between approximately 100° F. to approximately 150° F. (approximately 37° C. to approximately 65.5° C.).

86. The method of claim 80 wherein said preheated juice is rapidly heated by direct steam injection into said preheated juice.

87. The method of claim 80 wherein said preheated juice is rapidly heated by direct steam infusion of said preheated juice.

88. The method of claim 80 wherein after rapidly cooling said juice, desirable flavor components are added back to said juice.

89. The method of claim 80 wherein said citrus juice is selected from the group consisting of orange, grapefruit, lime and lemon juice.

90. The method of claim 80 wherein said citrus juice is not from concentrate citrus juice.

91. The method of claim 80 wherein said citrus juice is concentrated citrus juice.

92. The method of claim 80 wherein said citrus juice is single strength juice reconstituted from concentrated citrus juice.

93. The method of claim 80 wherein said citrus juice includes freshly extracted juice.

94. The method of claim 80 wherein said citrus juice includes stored juice.

95-98. (canceled)

99. A citrus juice pasteurized by the method of claim 80.

100-101. (canceled)
